(19) United States
(12) Patent Application Publication
(10) Pub. No.: US 2010/0131861 A1
(43) Pub. Date: May 27, 2010

(54) Method and System for Instantly Transmitting Interactive Image

(76) Inventor: Chien-Tang Tseng, Hsinchih (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/559,596

(22) Filed: Sep. 15, 2009

(30) Foreign Application Priority Data
Nov. 25, 2008 (TW) 097145553

(51) Int. Cl. G06F 3/048; G06F 15/16

(52) U.S. Cl. 715/753; 709/205

(57) ABSTRACT

A method and a system for instantly transmitting an interactive image are disclosed. The method is applied in a low bandwidth Internet connection for sharing the interactive image instantly between a first computer and a second computer. The image includes a main image and a track mark, and the track mark is generated by any one of the two computers. The method of the present invention comprises steps of: (A) transmitting the main image from the first computer to the second computer so that the main image is displayed on both computers simultaneously; and (B) generating the track mark on the main image by one of the computers and transmitting the track mark instantly to the other computer, wherein step (B) further comprises: (B1) collecting track information of the track mark formed by a plurality of track points with a specific sampling rate; (B2) down sampling the collected track information according to a difference degree between any two adjacent track points, so as to decrease the collected track information; and (B3) compressing and transmitting the decreased track information to the other computer via the low bandwidth Internet connection.

### BACKGROUND OF THE INVENTION

1. Field of the Invention

The present invention relates to a method and a system for instantly transmitting an interactive image, specifically to a method and a system, which can reduce the computational loading, for instantly transmitting an interactive image over limited bandwidth connections.

2. Description of the Related Art

With the advances in Internet technology, long distance communication is no loner a problem. However, the biggest problem about Internet transmission is the bandwidth. Specifically, sufficient network bandwidth is necessary for high definition transmission and good transmitting quality. Generally, the cost for upgrading the network bandwidth is high so most Internet transmission still needs highly effective packet and compression techniques to overcome the transmission problem.

Sharing photos instantly is one of the advantages that current long distance communication has, and a variety of instant messaging applications (application software such as MSN and Yahoo! Messenger) are available on the market now. Thus, when sharing photos, both communication sides can discuss about the shared photos instantly. However, if both sides want to discuss a specific part of the shared photo, the most important thing is to make sure that they are discussing on the same specific portion. To achieve this purpose, a common way is to instantly generate a track mark on the shared photo and then transmit the marked shared photo from the one who generates the track mark to the other side. And then, the two sides can have the same photo with the track mark thereon and discuss it with each other.

Please refer to FIG. 1, which shows an image or a photo that both communication sides are discussing. As shown in the figure, the photo includes a main image 11. The main image shows a house and a dog in the snow. If one side wants to discuss a specific portion of the photo 1, such as the dog on the right of the photo, the most convenient way is to mark the dog on photo with a track mark 12. However, when one side draws the track mark 12 on the shared photo, he or she has to retransmit the modified photo with track mark to the other side to show the marked portion. Nevertheless, the only difference between the modified photo and the original unmodified photo is the addition of the track mark, and nothing changes in the main image. Accordingly, it is considered that the retransmission of the whole image due to the partial change of the image or photo is a waste of bandwidth. Furthermore, the retransmission does not provide instantly communication since it might spend some additional time. Therefore, the present invention provides a method and a system for instantly transmitting a track mark on the shared image over limited bandwidth to mitigate and/or obviate the aforementioned problems.

### SUMMARY OF THE INVENTION

An aspect of the present invention is to provide a method for instantly transmitting an image and a computer system which applies the method when communicating over limited bandwidth.

A further aspect of the present invention is to provide a method and a system for instantly transmitting an image that can reduce the computational loading of the computer processor. The method of the present invention is applied to a low bandwidth Internet connection for instantly sharing an image between two computers. The transmitted image includes a main image and a track mark, and the track mark is generated by any of the two computers. The method of the present invention includes the following steps:

(A) transmitting the image including the main image from the first computer to the second computer so that the main image is displayed on the first and the second computers simultaneously; and

(B) drawing a track mark on the main image by one of the first computer and the second computer and instantly transmitting the track mark to the other computer, wherein the step (B) further includes:
(B1) collecting track information of the track mark with a specific sampling rate, wherein the track mark is substantially formed by a plurality of track point;
(B2) down-sampling the collected track information according to a degree of difference between any two adjacent collected track points, so as to decrease the collected track information; and
(B3) compressing and transmitting the decreased track information to the other computer via the low bandwidth Internet connection.

In preferred embodiments, the specific sampling rate is fifteen (15) times per second. The track information includes coordinate information, track shape information, or color information. The track information of the track mark is collected from an operating system, such as Windows™ operating system. More specifically, when a computer cursor control device (e.g. a mouse) is being operated, a computer's operating system can detect moving information of the computer cursor control device, whereby the coordinate information can be obtained.

In one embodiment, the degree of difference between any two adjacent collected track points is substantially calculated and obtained according to the coordinate information of any two adjacent track points, whereby track points which are too close to each other can be deleted, so as to decrease track information. In a further embodiment, a slope can be obtained based on the coordinate information of any two adjacent track points, whereby the slope of all adjacent track points can be calculated. The degree of difference can then be obtained based on any two adjacent slopes, and track points which are too close to each other are deleted, so as to decrease track information.

In a preferred embodiment, the step (B3) of the present invention can further includes a step (B31): reorganizing the decreased track information to convert the coordinate information and property information of each track point into a plurality of groups of classified data, so as to further compress the decreased track information. In addition, except the very first coordinate information of the track point, the coordinate information of any two adjacent track points can be represented by a variances with the coordinate information of the previous track point, whereby the information that needs to be stored can be decreased even more. Thus, the step (B3) of the present invention can further include a step (B32): storing the track information of a later track point based on a track information variance between a former track point and a current track information, whereby compressing the decreased track information can decrease data volume that needs to be transmitted.

In another embodiment, the present invention provides a method for instantly transmitting a track mark on a shared image. The method includes the following steps:

(A) providing and displaying the shared image on a first and a second computer simultaneously;

(B) forming the track mark on the shared image on the first computer and instantly transmitting the track mark to the second computer, wherein the step of instantly transmitting the track mark further includes the following steps:
(B1) collecting track information of each track point that forms the mark track with a sampling rate;
(B2) reorganizing and compressing the collected track information; and
(B3) instantly transmitting the reorganized and compressed track information to the second computer.

In addition, the present invention also provides an instant transmission system of interactive images. The system allows an interactive image to be instantly shared between two computers by using the method of the present invention. The instant transmission system of the present invention includes a sending computer and a receiving computer. The sending computer includes a graphic module and a first image processing module. The graphic module generates a track mark on a main image. The first image processing module collects and compresses track information which forms the track mark, so as to instantly transmit the compressed track information to the receiving computer via a low bandwidth Internet connection. Preferably, the first image processing module collects the track information of the track mark with a sampling rate of fifteen (15) track information per second.

The receiving computer includes a second image processing module. The second image processing module decompresses the received track information so as to restore the track mark on the main image.

In a preferred embodiment, the sending computer further includes a computer cursor control device, and the graphic module generates the track mark on the main image by using the computer cursor control device. In this embodiment, the track information includes coordinate information and property information, wherein the track mark is formed by the track points, and each track point contains at least one track information. The coordinate information is the moving information of the computer cursor control device detected in a computer's operating system. In other words, when the computer cursor control device (e.g. a mouse) is being operated (or moved), the computer's operating system detects the moving information of the computer cursor control device, whereby the coordinate information can be obtained. The property information is substantially the color, the width, or the shape of the track mark.

In another preferred embodiment, the first image processing module further includes a down sampling module for deleting track points which are too close to each other. In other words, the present invention can employ the down sampling module to perform the aforementioned step of decreasing collected track information.

In addition, the first image processing module can still further includes a data reorganization module for converting the coordinate information and property information of each track point into a plurality of groups of classified data, so as to further compress the decreased track information.

The first image processing module further includes a compression module for decreasing the track information of a later track point based on a track information variance between a former track point and a current track information, whereby compressing the decreased track information can decrease data volume that needs to be transmitted.

The second image processing module further includes an image compositor for displaying the track mark on the main image on the receiving computer.

Therefore, the interactive image which has the main image and the track mark is displayed on the sending computer and the receiving computer simultaneously. Thus, the instant transmission of the interactive image is achieved.

### BRIEF DESCRIPTION OF THE DRAWINGS

FIG. 1 shows a photo and a track mark thereon which are going to be shared.

FIG. 2 and FIG. 3 are respectively a system diagram and a block drawing of an instant transmission system of interactive images in accordance with one embodiment of the present invention.

FIG. 4 and FIG. 5 are block drawings respectively based on a first and a second image processing module in FIG. 3.

FIG. 6 illustrates a flowchart of a method for instantly transmitting an interactive image in accordance with one embodiment of the present invention.

FIG. 7 illustrates converting the coordinate and property of each track point to a plurality of groups of classified data.

FIG. 8 illustrates a flowchart of the method for instantly transmitting an interactive image in accordance with another embodiment of the present invention.

### DETAILED DESCRIPTION OF THE PREFERRED EMBODIMENT

The advantages and innovative features of the invention will become more apparent from the following detailed description when taken in conjunction with the accompanying drawings.

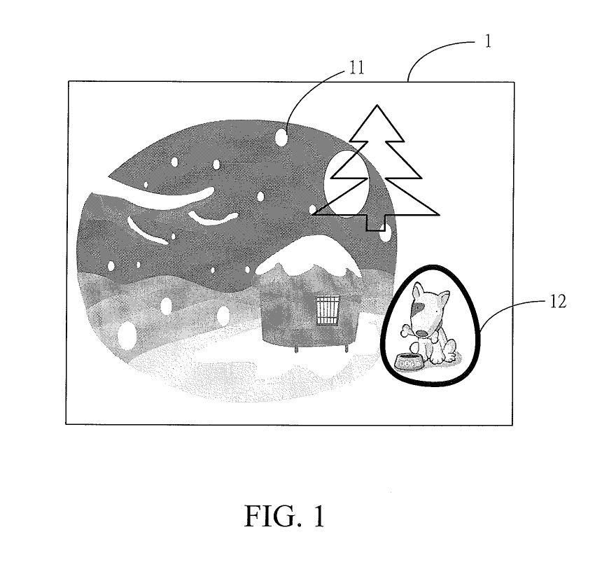

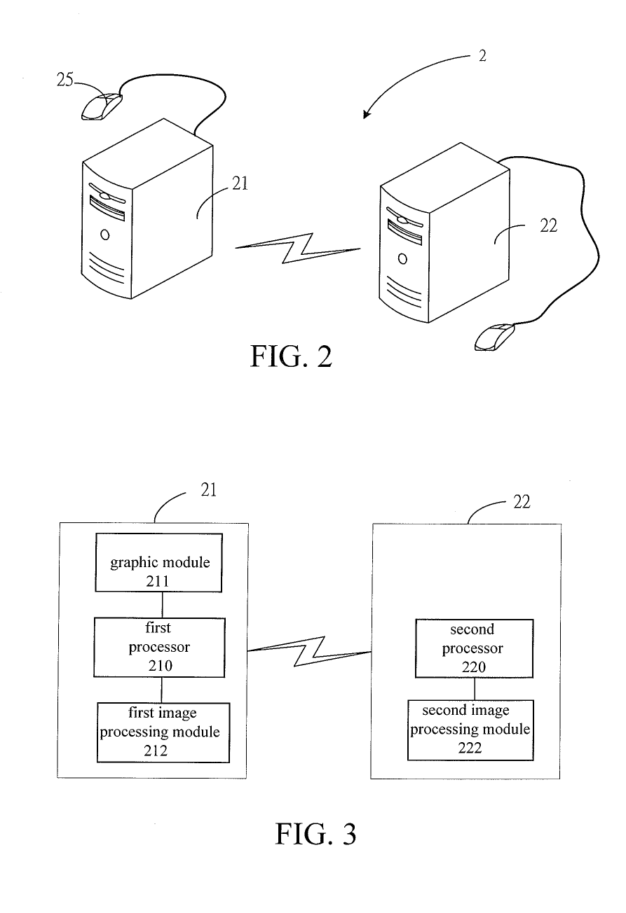

The present invention provides an instant transmission system of interactive images allowing an interactive image 1 (e.g. including a main image 11 and a track mark 12 as shown in FIG. 1) to be instantly shared between two computers via a low bandwidth Internet connection (e.g. bandwidth lower than 100 kbps). More specifically, please refer to FIGS. 2 and 3 first. An instant transmission system 2 of the present invention comprises a sending computer 21 and a receiving computer 22, wherein the sending computer 21 and the receiving computer 22 are sharing the interactive image 1. The sending computer 21 comprises a graphic module 211 and a first image processing module 212. The graphic module 211 can generate a track mark on a shared main image (e.g. the main image 11 and track mark 12 as shown in FIG. 1; the main image and the track mark are respectively numbered with 11 and 12 in the following). The first image processing module 212 is used for collecting and compressing track information of the track mark 12 so that the compressed track information can be instantly transmitted to the receiving computer 22 via the low bandwidth Internet connection. Preferably, the first image processing module 212 collects the track information of the track mark with a sampling rate of fifteen (15) times per second. The track mark 12 is substantially formed by a plurality of track points. Because of the limitation of human visual persistence, the track mark 12 which is being instantly transmitted with an update frequency of about fifteen (15) frames per second seems to be instantly drawn without discontinuity. Thus, in a preferred embodiment, the track information of the track mark (track point) is collected with a specific sampling rate of 15 Hz, but which is not used to limit the present invention.

In the instant transmission system 2 of the present invention, the sending computer 21 substantially comprises a first processor 210 for executing an application program to perform the aforementioned drawing and image processing functions of the graphic module 211 and the first image processing module 212, respectively.

The receiving computer 22 comprises a second image processing module 222. The second image processing module 222 decompresses the received track information to restore the track mark 12 on the main image 11, wherein the track mark 12 is transmitted from the sending computer 21. The receiving computer 22 substantially comprises a second processor 220 for executing an application program to perform the image decompression function of the second image processing module 222.

In a preferred embodiment, the sending computer 21 further comprises a computer cursor control device 25 (e.g. a mouse, a handwriting recognition input device with a stylus, a digitizer, or other similar input devices). The graphic module 211 generates the track mark 12 on the main image 11 by using with the computer cursor control device 25. In this embodiment, the track information comprises coordinate information and property information that contained in each track point of the track mark 12. The coordinate information is the moving information of the computer cursor control device 25 detected by a computer's operating system (e.g. Windows™ operating system). In other words, when the computer cursor control device 25 is being operated (or moved), the computer's operating system detects the moving information of the computer cursor control device 25, whereby the coordinate information can be obtained. The property information is substantially the color, the width, or the shape of the track mark 12.

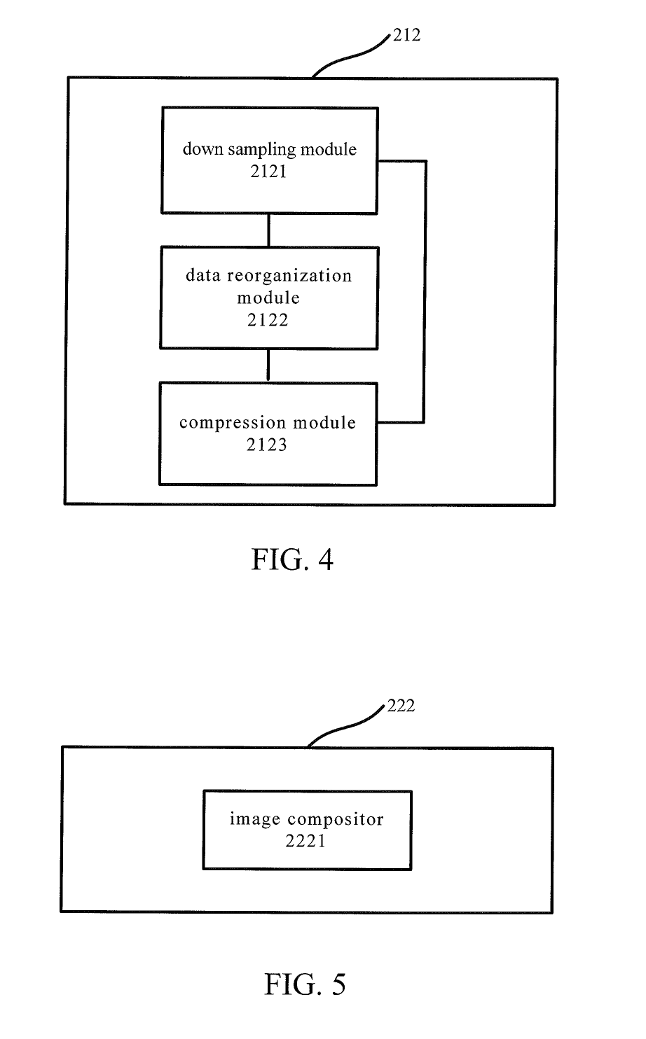

Please refer to FIG. 4. In another preferred embodiment, the first image processing module 212 further comprises a down sampling module 2121 for deleting track points which are too close to each other so as to decrease the track information. This function will be described in detail below in the procedure of the method.

In addition, the first image processing module 212 still further comprises a data reorganization module 2122 for converting the coordinate information and the property information of each track point into a plurality of groups of classified data, so as to further rearrange the decreased track information. This function will be described in detail below in the procedure of the method.

The first image processing module 212 further comprises a compression module 2123. The compression module 2123 decreases the track information of a later track point based on a track information variance between a former track point and a current track information, whereby compressing the decreased track information can decrease data volume that needs to be transmitted. In this embodiment, this function will also be described in detail below in the following procedure of the method.

As shown in FIG. 5, the second image processing module 222 further comprises an image compositor 2221, whereby the track mark 12 can be composed on the shared main image 11 on the receiving computer 22. Therefore, the main image 11 and the track mark 12 are simultaneously displayed on the sending computer 21 and the receiving computer 22. The objective of instantly transmitting an interactive image is then achieved.

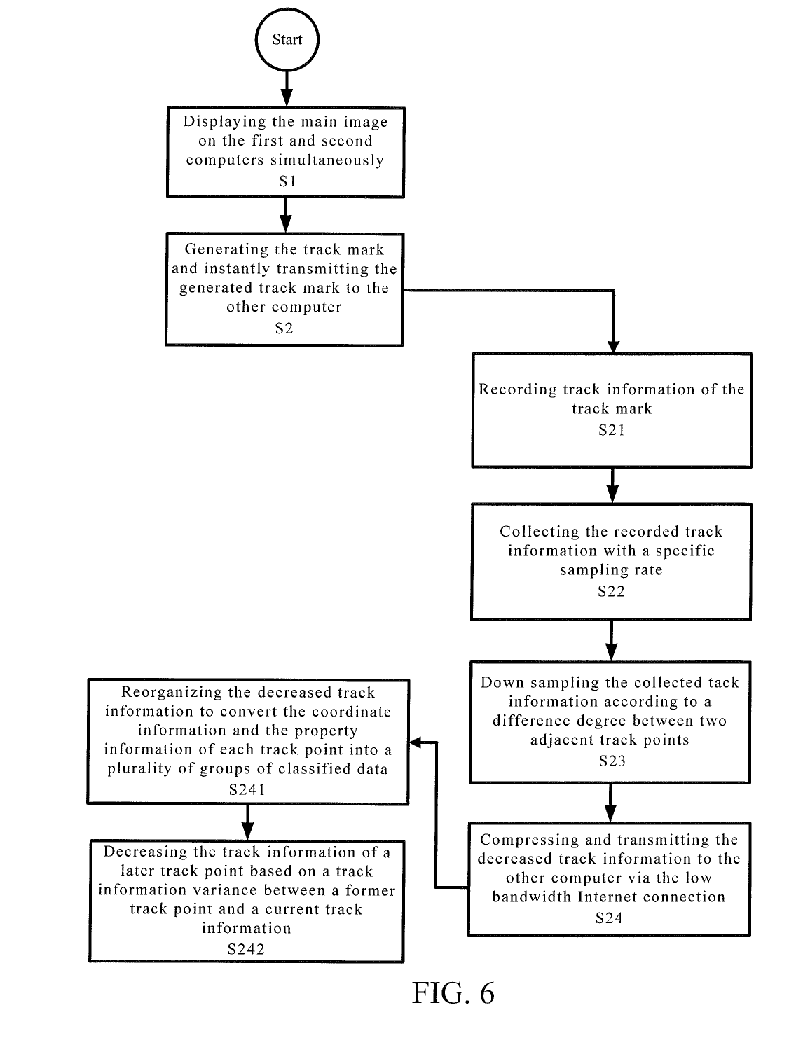

The present invention also discloses a method for instantly transmitting an interactive image. The method, applied in a low bandwidth Internet connection, allows the interactive image to be shared between a first and a second computer. The reference numerals in FIG. 1 are used herein and after for the interactive image 1, that is, the interactive image 1 comprises a main image 11 and a track mark 12. Also, the track mark 12 is generated by any of the first or the second computers. More specifically, the method of instantly transmitting an interactive image of the present invention can provide all the mechanisms via the aforementioned system. For example, in order to simplify the description, in this embodiment, a first computer is equivalent to the aforementioned sending computer 21 so the track mark 12 is generated by the first computer. Also, a second computer is equivalent to the aforementioned receiving computer 22. Thus, although the two computers are named, respectively, the first computer and the second computer below, the same reference numerals 21 and 22 are applied to them in order to simplify the description. Please refer to FIG. 6. The method of the present invention comprises the following steps:

Step S1: transmitting the main image 11 from the first computer 21 to the second computer 22 so that the main image 11 is displayed on the first and second computers 21, 22 simultaneously. For example, the image processing modules 212, 222 of the first and second computers 21, 22 can perform the function.

Step S2: generating the track mark 12 on the main image 11 by one of the first computer 21 and the second computer 22 and instantly transmitting the generated track mark 12 to the other computer. In order to simplify the description herein and after, the first computer 21 works as the sending computer, but which is not used to limit the present invention. Any one of the computers can be the sending computer. In the step of instantly transmitting the track mark 12, the method of the present invention further comprises:

Step S21: recording track information of the track mark 12, wherein the track mark 12 is substantially formed by a plurality of track points. More specifically, the track mark 12 is substantially formed by a plurality of continuous track points. This step may be substantially automatically performed by the operating system. For example, the operating system automatically records the position of a cursor, whereby the track information of the track mark 12 can be obtained.

Step S22: collecting the recorded track information with a specific sampling rate. In preferred embodiments, the specific sampling rate is fifteen (15) track information per second. As mentioned above, because of the limitation of human visual persistence, the image is instantly displayed almost without discontinuity with a collecting frequency of fifteen (15) frames per second. Thus, in a preferred embodiment, the track information of the track mark (including every track point) is collected with a specific sampling rate, fifteen (15) per second, but which is not used to limit the present invention.

The track information comprises coordinate information, track shape information, or color information. The track information of the track mark 12 can be collected from an operating system, such as the Microsoft Windows™ operating system. More specifically, when the computer cursor control device (e.g. the aforementioned mouse 25) is being operated, a computer's operating system detects the moving information of the computer cursor control device (e.g. the position of the cursor), whereby the coordinate information can be obtained. The track shape information can comprise of the width of the track mark. The operating system can provide much more information about the computer cursor control device. The sampling rate can be as high as eighty (80) pieces of information per second. However, as mentioned above, a frequency of 15 frames per second is high enough for human eyes. Thus the present invention collects the track information with the specific frequency, 15 pieces per second. In other words, the collecting frequency of all track information is cut down to 15 pieces per second.

In addition, the property information such as width information and time information of each track point can also be obtained from the track information about the computer cursor control device 25 (such as a mouse) in the operating system. For example, the present invention can determine on which computer the track mark is generated first according to the time information and can display the last track point on top (i.e. overlapping on other track point) according to time sequence information.

Next, the present invention performs step S23: down sampling the collected track information according to a degree of difference between two adjacent collected track points, so as to decrease the collected track information. For example, as mentioned above, the present invention can employ the down sampling module 2121 of the first image processing module 212 to delete track points which are too close to each other.

In one embodiment, the difference degree is substantially obtained based on the coordinate information of any two adjacent track points. The track points which are too close to each other can be deleted, so as to decrease track information. In this embodiment, the coordinate information of each track point can be obtained from the operating system, so a slope can be obtained based on the coordinate information of any two adjacent track points, whereby the slope of all adjacent track points can be calculated. The difference degree can then be obtained based on any two adjacent slopes, and track points which are too close to each other are deleted, so as to decrease the track information.

Next, step S24 is performed: compressing and transmitting the decreased track information to the other computer via the low bandwidth Internet connection.

Please refer to FIG. 6. In a preferred embodiment, in order to enhance the transmission performance, step S24 of the present invention can further comprise step S241: reorganizing the decreased track information to convert the coordinate information and the property information (such as color, shape, or time information) of each track point into a plurality of groups of classified data, so as to further rearrange the decreased track information. For example, as mentioned above, the present invention can employ the data reorganization module 2122 of the first image processing module 212 to convert the coordinate information and property information of each track point into a plurality of groups of classified data, so as to further rearrange the decreased track information.

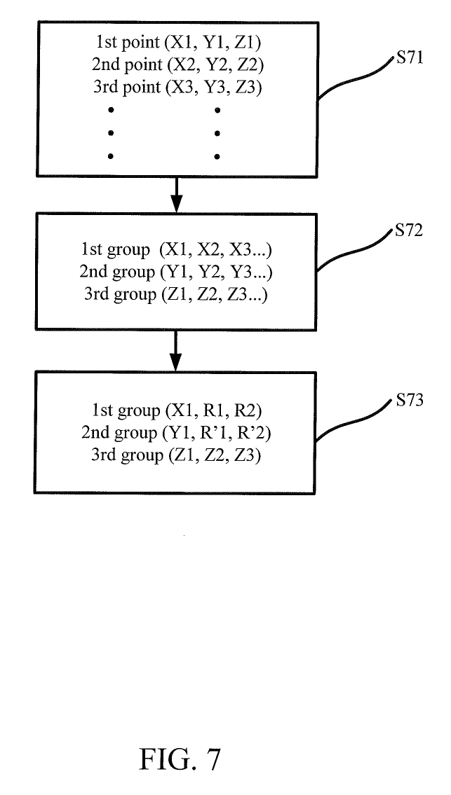

In order to describe step S241 in detail, please refer to the example illustrated in FIG. 7 first. The coordinate information of each track point can be denoted as X, Y; the property information can be denoted as Z. As illustrated in step S71, the first track point is defined by (X1, Y1, Z1). If the track information is transmitted directly, all the track information of a great number of track points may need to be transmitted. However, as shown in step S72, when dividing track information into three groups as X-group, Y-group, and Z-group, only three groups of track information need to be transmitted when the track information is transmitted. This can decrease data volume that needs to be transmitted.

In addition, the coordinate information of any two adjacent track points can be represented by a variances with the very first of the track point. Thus, step S24 of the present invention (as shown in FIG. 6) further comprises step S242 of decreasing the track information for data compression. The step of S242 is to decrease the track information of a later track point based on a track information variance between a former track point and a current track information, whereby compressing the decreased track information can decrease data volume that needs to be transmitted. For example, the first image processing module 212 further comprises the compression module 2123. The compression module 2123 decreases the track information of a later track point based on a track information variance between a former track point and a current track information, whereby compressing the decreased track information can decrease data volume that needs to be transmitted.

More specifically, the coordinate of the second track point of the plurality of continuous track points which form the track mark 12 is actually the coordinate of the first track point plus the variance between the first track point and the second track point. The third track point is actually the coordinate of the second track point plus the variance between the second track point and the third track point; and so on. Until the last track point is calculated. Thus, apparently, the coordinate information of the track points following the second track point can be simply stored as the coordinate of the first track point and the variance in the following points. Therefore, data volume that needs to be transmitted can be decreased even more. As illustrated in step S73 in FIG. 7, there are only three groups of the classified track information. Only variance R and R′ need to be recorded for each group of information, except for the very first track point.

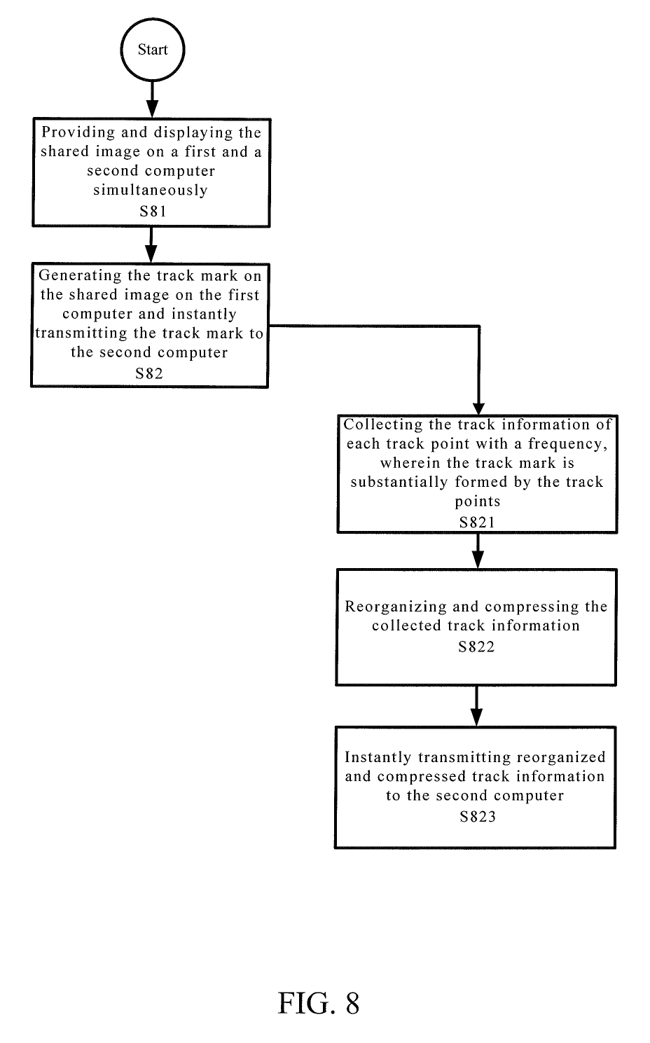

Please refer to FIG. 8. In the other embodiment, the present invention provides a method for instantly transmitting a track mark on a shared image. The method comprises the following steps:

Step S81: providing and displaying the shared image on a first and a second computer simultaneously.

Step S82: generating the track mark on the shared image on the first computer and instantly transmitting the track mark to the second computer, wherein the step of instantly transmitting the track mark further comprises the following steps:

Step S821: collecting the track information of each track point with a frequency, wherein the track mark is substantially formed by the track points.

Step S822: reorganizing and compressing the collected track information.

Step S823: instantly transmitting reorganized and compressed track information to the second computer.

It is understood that the first computer, second computer, sending computer, or receiving computer of the present invention is not limited to a certain type of computer. Although what is shown in the figure is a conventional desktop, actually the present invention can be applied to all kinds of computers, such as laptops, tablet personal computers, or personal digital assistants.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A method for instantly transmitting an interactive image, the method being applied in a low bandwidth Internet connection for instantly sharing the interactive image between a first computer and a second computer, wherein the interactive image comprises a main image and a track mark, and the track mark is generated by any of the first computer or the second computer, the method comprising:
(A) transmitting the main image from the first computer to the second computer so that the main image is displayed on the first computer and the second computers simultaneously; and
(B) generating the track mark on the main image by one of the first computer and the second computer and instantly transmitting the track mark to the other computer, wherein in the step of instantly transmitting the track mark further comprises:
(B1) collecting track information of the track mark with a specific sampling rate, wherein the track mark is substantially formed by a plurality of track point;
(B2) down sampling the collected tack information according to a difference degree between any two adjacent track points, so as to decrease the collected track information; and
(B3) compressing and transmitting the decreased track information to the other computer via the low bandwidth Internet connection.

2. The method as claimed in claim 1, wherein the specific sampling rate is fifteen (15) track information per second.

3. The method as claimed in claim 1, wherein the track information of the track mark comprises coordinate information, track shape information, time information, or color information.

4. The method as claimed in claim 3, wherein the coordinate information is collected from moving information of a computer cursor control device detected in a computer's operating system.

5. The method as claimed in claim 3, wherein in step (B2), the difference degree is substantially obtained based on the coordinate information of any two adjacent track points, whereby the track points which are too close to each other can be deleted.

6. The method as claimed in claim 5, wherein in step (B2), a slope can be obtained based on the coordinate information of any two adjacent track points, whereby the slope of all adjacent track points can be calculated, and the difference degree can then be obtained based on any two adjacent slopes, so as to delete track points which are too close to each other.

7. The method as claimed in claim 1, wherein the track information comprises coordinate information and property information of each track point, and the compressing step (B3) further comprises:
(B31) reorganizing the decreased track information to convert the coordinate information and property information of each track point into a plurality of groups of classified data, so as to further compress the decreased track information.

8. The method as claimed in claim 7 further comprising:
(B32) decreasing the track information of a later track point based on a track information variance between a former track point and a current track information, whereby compressing the decreased track information can decrease data volume that needs to be transmitted.

9. An instant transmission system of interactive images, the system comprising:
a sending computer for transmitting a main image to a receiving computer via a low bandwidth Internet connection so that the main image is displayed on the sending computer and the receiving computer simultaneously, wherein the sending computer further comprises:
a graphic module for generating a track mark on the main image; and
a first image processing module for collecting and compressing track information of track points that forms the track mark, so as to instantly transmit the compressed track information to the receiving computer via the low bandwidth Internet connection.

10. The system as claimed in claim 9, wherein the first image processing module collects the track information of the track mark with a sampling rate of fifteen (15) track information per second.

11. The system as claimed in claim 9, wherein the graphic module generates the track mark on the main image by using with a computer cursor control device.

12. The system as claimed in claim 11, wherein the track information comprises coordinate information and property information of each track point that forms the track mark.

13. The system as claimed in claim 12, wherein the coordinate information is moving information of the computer cursor control device detected in a computer's operating system.

14. The system as claimed in claim 12, wherein the property information is substantially color, width, time, or shape of the track mark.

15. The system as claimed in claim 12, wherein the first image processing module further comprises a down sampling module for deleting track points which are too close to each other.

16. The system as claimed in claim 12, wherein the first image processing module further comprises a data reorganization module for converting the coordinate information and the property information of each track point into a plurality of groups of classified data, so as to further compress the decreased track information.

17. The system as claimed in claim 16, wherein the first image processing module further comprises a compression module for decreasing the track information of a later track point based on a track information variance between a former track point and a current track information, whereby compressing the decreased track information can decrease data volume that needs to be transmitted.

18. The system as claimed in claim 9, wherein the receiving computer further comprises a second image processing module, and the second image processing module further comprises an image compositor for displaying the track mark on the main image.

19. The system as claimed in claim 9, wherein the receiving computer further comprises: a second image processing module for decompressing the received track information to restore the track mark on the main image.

20. A method for instantly transmitting a track mark on a shared image, the method comprising:
(A) providing and displaying the shared image on a first computer and a second computer simultaneously;
(B) forming a track mark on the shared image on the first computer and instantly transmitting the track mark to the second computer, wherein the step of instantly transmitting the track mark further comprises:
(B1) collecting the track information of each track point that forms the track mark with a frequency;
(B2) reorganizing and compressing the collected track information; and
(B3) instantly transmitting the reorganized and compressed track information to the second computer.
